(19) United States
(12) Patent Application Publication
(10) Pub. No.: US 2025/0237010 A1
(43) Pub. Date: Jul. 24, 2025

(54) Selenium Containing Antimicrobial Compound as a Reacitve Dye and Cross-Linking Treatment for Textile Applications

(71) Applicant: Texas Tech University System, Lubbock, TX (US)

(72) Inventors: Ted W. Reid, Wolfforth, TX (US); Noureddine Abidi, Lubbock, TX (US); Phat L. Tran, Lubbock, TX (US); Nicholas Bergfeld, Lubbock, TX (US)

(21) Appl. No.: 18/697,938

(22) PCT Filed: Oct. 3, 2022
(86) PCT No.: PCT/US2022/045507

§ 371 Date: Apr. 2, 2024

Related U.S. Application Data
(60) Provisional application No. 63/253,326, filed on Oct. 7, 2021.

(51) Int. Cl. D06P 1/384; A01N 25/34; A01N 55/00; A01P 1/00; D06P 3/00

(52) U.S. Cl. CPC D06P 1/384; A01N 25/34; A01N 55/00; A01P 1/00; D06P 3/008

(57) ABSTRACT

The present invention includes compositions and method of treating a textile with an antimicrobial agent, the method comprising contacting the textile with an antimicrobial agent that comprises a reactive dye or crosslinking agent comprising an organo-selenium compound in a treatment solution.

### CROSS-REFERENCE TO RELATED APPLICATIONS

This application claims priority to U.S. Provisional Application Ser. No. 63/253,326, filed Oct. 7, 2021, the entire contents of which are incorporated herein by reference.

### TECHNICAL FIELD OF THE INVENTION

The present invention relates in general to the field of antimicrobial compounds, and more particularly, to selenium containing antimicrobial compounds as reactive dyes or as cross-linking agent for textile applications.

### STATEMENT OF FEDERALLY FUNDED RESEARCH

None.

### BACKGROUND OF THE INVENTION

Without limiting the scope of the invention, its background is described in connection with antimicrobial agents.

Maintaining sanitary conditions in hospitals, clean rooms and other facilities requires a combination of strict protocols and the right equipment. Clothing, linen, furniture, and instruments all rely on the use of antimicrobial fabrics to help promote clean, sanitary working environments. An antimicrobial fabric is any textile that offers protection against bacteria, mold, mildew, and/or other hazardous microbes. These materials are typically created by treating the fabric with a topical chemical that inhibits the growth of pathogens or by using yarns which are designed to provide inherent antimicrobial functionality at the microscopic level. Different chemicals and textiles have different levels of antimicrobial effectiveness. Some products slow the spread of pathogens over time, while others are designed to kill spore cells on contact. Various materials have been used or are currently under investigation for use in creating antimicrobial fabrics (e.g., cotton) including chitosan, chitosan derivatives, silver, triclosan, various metals, metal salts, phenols, and naturally occurring materials.

Silver has been used as an antibacterial material for many years and studies have shown that free silver ions released from silver can effectively kill bacteria and is the primarily mechanism responsible for silver's antibacterial properties. Various forms of silver including zero-valent silver, silver oxide, ionic silver, and silver-containing molecular complexes have been shown to be active against different bacterial strains. Nanoscale forms of silver and other antibacterial metals such as copper and zinc oxide are effective at deactivating bacterial growth. Silver nanoparticles are increasingly used to fabricate antimicrobial textiles for their broad-spectrum antibiotic properties against a range of bacterial strains including common Gram-negative bacteria, Gram-positive bacteria, and drug-resistant bacteria. Silver finished cotton fabrics show a reduction rate of greater than 90% against both E. coli (Gram-negative) and S. aureus (Gram-positive) bacteria at concentrations of 10 g/L, and the reduction for both types of bacteria increased to 99.99% with concentrations of silver at or beyond 30 g/L.

Though silver has proved to be an effective antimicrobial agent for textile products, it has a variety of deficiencies including the laundering of silver-based textiles can release the silver material into the environment exposing the general population. Migration of silver from the textile to human sweat can also increase human dermal exposure creating concerns about effects on human physiology. In addition to the environmental issues associated with use of silver for antimicrobial protection, the material is expensive (e.g., approx. $24/oz, Aug. 7, 2021, spot price). Various methods have been adopted for coating silver onto a textile surface, including plasma technology, UV irradiation, sol-gel processing, and in-situ reduction of silver ions to metallic silver.

Other metal ions with antimicrobial properties—while silver has been successfully used as an effective antimicrobial agent for wound management, other metal ions have also proven effective in preventing bacterial growth including zinc and copper ions. These materials are non-toxic to humans and can be attached to wound dressings through salt formation with anionic groups or chelation with amine groups in the fibers/wound dressings. Chitosan fibers treated with zinc and copper compounds have the combined antimicrobial properties of the chitosan and the metal ions. Naturally occurring antimicrobial materials—Melaleuca alternifolia oil (e.g., tea tree oil) has demonstrated promising efficacy in treating wound infections. Tea tree oil has been used as a botanical medicine with good antimicrobial and anti-inflammatory properties. There are few apparent side effects to using tea tree oil topically in low concentrations for conditions such as contact dermatitis.

However, the above techniques are not effective in preventing the release of toxic materials into the environment because by, e.g., laundering. As a result, techniques which prevent incorporated silvers release into the environment through laundering are urgently needed. Further, a need remains for novel materials and methods that reduce or eliminate microbial contamination (bacterial, fungal and viral) without the high costs of precious metals or the need to use harsh chemical reactants, leaching, and by-products.

### SUMMARY OF THE INVENTION

As embodied and broadly described herein, an aspect of the present disclosure relates to a method of treating a textile with an antimicrobial agent, the method comprising: contacting the textile with an antimicrobial agent that comprises a reactive dye or crosslinking agent comprising an organo-selenium compound in a treatment solution. In one aspect, the step of contacting the textile comprises dosing the textile with the treatment solution having a concentration of the antimicrobial agent sufficient to react with the textile, wherein the treatment solution comprises the organo-selenium compound solution. In another aspect, the treatment solution is an organo-selenium compound-based solution comprising the organo-selenium compound, water, salt, alkali and water. In another aspect, the organo-selenium compound is a diselenocyanuric chloride, diselenocyanuric bromide, diselenocyanuric fluoride, or diselenocyanuric iodine. In another aspect, the antimicrobial agent is selected from the following structures where R, is an organic moiety that facilitates the attachment of either the hydroxyl or carboxyl groups of the molecule, to the hydroxyls of cellulose, or molecules selected from:

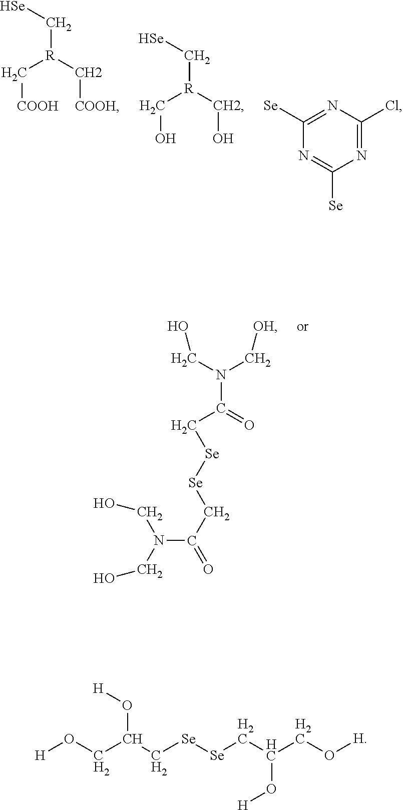

In another aspect, the textile is antimicrobial against both gram positive and gram negative bacteria.

In another aspect, the textile is antimicrobial without selenium in the organo-selenium compound leaching from the textile. In another aspect, the textile is selected from at least one of: cotton, wool, silk, hemp, viscose, pashm, camel, cashmere, mohair, rabbit, flax, linen, jute, ramie, sisal cork, ramie, jute, or coir. In another aspect, the method further comprises blending the textile with one or more synthetic fibers to the textile selected from at least one of: rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof. In another aspect, the textile is formed into a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or ahead covering.

As embodied and broadly described herein, an aspect of the present disclosure relates to an antimicrobial textile made by a method comprising: treating a textile with an antimicrobial agent, the method comprising: contacting the textile with an antimicrobial agent that comprises a reactive dye comprising an organo-selenium compound in a treatment solution or a cross-linking organoselenium compound in a treatment solution. In one aspect, the step of contacting the textile comprises dosing the textile with the treatment solution having a concentration of the antimicrobial agent sufficient to react with the textile, wherein the treatment solution is a foam-based solution. In another aspect, the organo-selenium compound is a: diselenocyanuric chloride, diselenocyanuric bromide, diselenocyanuric fluoride, or diselenocyanuric iodine or other organoselenium crosslinking compounds, or wherein the antimicrobial agent has the more general structure where R, is an organic moiety that facilitates the attachment of either the hydroxyl or carboxyl groups of the molecule, to the hydroxyls of cellulose, or molecules selected from:

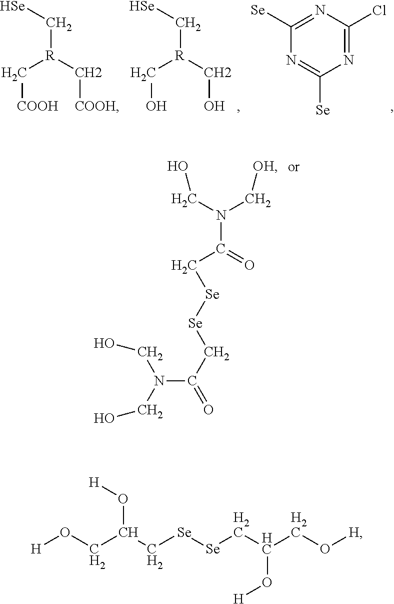

combinations thereof. In another aspect, the treatment solution is a cross-linking organo-selenium compound, catalyst, wetting agent, and water. In another aspect, the treatment solution is the organo-selenium compound, water, salt, alkali and water. In another aspect, the textile is antimicrobial against both gram positive and gram negative bacteria. In another aspect, the textile is antimicrobial without selenium in the organo-selenium compound leaching from the textile. In another aspect, the textile is selected from at least one of cotton, wool, silk, hemp, viscose, pashm, camel, cashmere, mohair, rabbit, flax, linen, jute, ramie, sisal cork, ramie, jute, or coir. In another aspect, the antimicrobial textile further comprises blending the textile with one or more synthetic fibers to the textile selected from at least one of: rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof. In another aspect, the textile is formed into a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or a head covering.

As embodied and broadly described herein, an aspect of the present disclosure relates to a system for making an antimicrobial textile, the system comprising: in a container contacting a textile with an antimicrobial agent that comprises a reactive dye comprising an organo-selenium compound in a treatment solution under conditions and for a time sufficient for the organo-selenium compound to chemically attach to the textile. In one aspect, the textile comprises fibers that are contacted to, or coated with, the antimicrobial agent comprising an organo-selenium reactive dye or a cross-linking agent. In another aspect, the organo-selenium compound is a diselenocyanuric chloride, diselenocyanuric bromide, diselenocyanuric fluoride, or diselenocyanuric iodine, or crosslinking structures, or wherein the antimicrobial agent has the structure where R, is an organic moiety that facilitates the attachment of either the hydroxyl or carboxyl groups of the molecule, to the hydroxyls of cellulose, or molecules selected from:

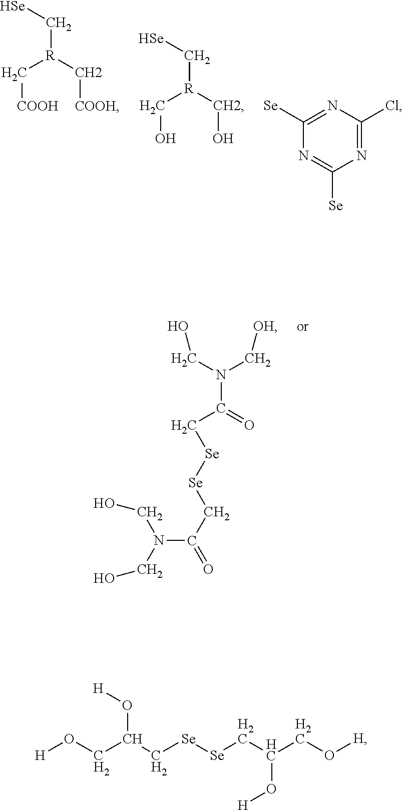

combinations thereof. In another aspect, the textile is antimicrobial against both gram positive and gram negative bacteria. In another aspect, the textile is antimicrobial without selenium in the organo-selenium compound leaching from the textile. In another aspect, the textile is selected from at least one of cotton, wool, silk, hemp, viscose, pashm, camel, cashmere, mohair, rabbit, flax, linen, jute, ramie, sisal cork, ramie, jute, or coir. In another aspect, the textile further comprises a blend of the textile with one or more synthetic fibers to the textile selected from at least one of rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof. In another aspect, the textile is formed into a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or a head covering.

### BRIEF DESCRIPTION OF THE DRAWINGS

For a more complete understanding of the features and advantages of the present invention, reference is now made to the detailed description of the invention along with the accompanying figures and in which:

FIGS. 1A and 1B are graphs that compares the colony forming units (CFUs) per sample of bacteria on a fabric, showing total bacterial killing with the organoselenium compound, and no killing without the organoselenium compound. In this example, the organoselenium compound was applied to the fabric as a reactive dye. FIG. 1A shows the effect on Staphylococcus aureus and FIG. 1B on Pseudomonas aeruginosa.

FIG. 2 is a graph that compares the colony forming units (CFUs) per sample of fungi on a fabric, showing total fungal killing with the organoselenium compound, and no killing without the organoselenium compound. In this example, the organoselenium compound was applied to the fabric as a crosslinking organoselenium compound.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Cellulose is the most abundant, natural, renewable and biodegradable polymer on earth. Cellulose can be obtained from various sources such as rice, wheat, sugar cane, and other agricultural products, as well as from bacteria. Cellulose can be a useful material when dissolved and reformed into another physical form.

Cotton is the most cellulose-rich plant species. Mature cotton fiber contains >90% (w/w) crystalline cellulose, including its cellulosic secondary wall, which is surrounded by the cuticulated primary wall and is therefore a high degree of polymerization (DP) cellulose. Cellulose in the cotton fiber has numerous applications. However, many of these applications require the cotton to be dissolved first. The crystalline structure and the strong hydrogen-bond network make it thermally and chemically stable.

As used herein the term, “cellulose” and “cellulose substrate” refer to native cellulose from any source such trees, cotton, any vascular plant (angiosperms and gymnosperms), any non-vascular plant such as algae, mosses, liverworts, any animal that synthesizes cellulose (such as tunicates or sea squirts), any prokaryotic organism (such as cyanobacteria, purple bacteria, archaebacteria, etc.). The cellulose may be from an organism that has one or more cellulose synthase genes present. Furthermore, cellulose also includes any derivatized form of cellulose such as cellulose nitrate, cellulose acetate, carboxymethylcellulose, etc. Cellulose for use with the present invention includes any form of cellulose, such as native crystalline cellulose, which includes not only the native crystalline form (called cellulose I, in its alpha and beta sub allomorphs, all ratios, whether pure alpha or pure beta). Cellulose for use with the present invention also includes all processed crystalline celluloses, which deviates from the native form of cellulose I, such as cellulose II (which is a precipitated crystalline allomorph that is thermodynamically more stable than cellulose I). Further, cellulose for use herein includes all variations of molecular weights ranging from the lowest (oligosaccharides, 2-50 glucan monomers in a β-1,4 linkage to form a glucan chain), low molecular weight celluloses with a degree of polymerization (DP), which is the number of glucose molecules in the chain, from 5 to several hundred, on up to the highest DP celluloses known (e.g., 15,000 from some Acetobacter strains, to 25,000 from some algae). The present invention may also use all variations of non-crystalline cellulose, including but not limited to, nematic ordered cellulose (NOC).

In cellulose, the polysaccharides are linear chains of several hundred to many thousands of β(1→4) linked D-glucose units. Cellulose is primarily made from plants, but is also available from algae and bacteria for use with the present invention. Typically, cellulose is mainly used to produce paperboard and paper, but can be converted into a wide variety of woven or non-woven derivative products such as cellophane and rayon. Non-limiting examples of plants from which cellulose can be obtained are trees, crop plants (such as, e.g., corn, wheat, sorgum, switchgrass, salix, poplar), or plants most often used for clothing such as cotton, hemp. Furthermore, cellulose can be used in the conversion of cellulose from energy crops into biofuels such as cellulosic ethanol. The dissolved cellulose materials of the present invention can be used for a wide variety of industrial, commercial, home, healthcare, dermal care, and other uses such as filters. Non-limiting examples of uses for cellulose include for use in cosmetics, cosmoceuticals, pharmaceutical formulations, adhesives, binders, consumables, bandages, thickening agents, 3-D printing, cellophane, linen, clothing, furnishings, woven products, knit products, non-woven products, absorbent or adsorbent materials for household or industrial use, in the form of powders, or the cellulose can be chemically modified. Non-limiting examples of chemical modifications to cellulose include but are not limited to cellulose acetate, cellulose triacetate, cellulose propionate, cellulose acetate propionate, nitrocellulose, cellulose sulfate, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, and/or carboxymethyl cellulose. The dissolved cellulose of the present invention provides a superior substrate for chemical modification. The dissolved cellulose (and modified cellulose) can also be formed into specific construction materials, due to the strength of cellulose and its ability to withstand dry and wet conditions, as well as being moldable into any of a variety of forms or spun into fibers to be used in materials such as non-wovens, wovens or knits. As a source of building materials, the cellulose can even be made fire retardant by the addition of fire retarding treatments such as with boric acid.

As used herein, the term “textile” refers to any fiber, filament, or yarn that can be made into a fabric or cloth, and also includes a resulting fabric or cloth material. Textiles may include, but are not limited to: natural fibers (protein or cellulosic) such as cotton, wool, silk, hemp, viscose, pashm, camel, cashmere, mohair, rabbit, flax, linen, jute, ramie, sisal cork, ramie, jute or coir. Synthetic fibers such as rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof, synthetic leather, mineral-based fibers such as fiberglass, and any conceivable combinations of these materials or related microfibers with which the reactive dye of the present invention can bind, ionically or chemically. Textile also includes, but is not limited to, any material, composite or product containing or partially composed of these aforementioned fibrous structural materials, such as blended materials that include, e.g., a combination of natural fibers, a natural fiber and/or a synthetic fiber, or combinations of synthetic fibers. The textile can be formed into any number of items, including but not limited to, a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, a sanitary napkin, a tampon, or a head covering.

The present invention uses selenium as the antimicrobial property conferring element. The organoselenium taught compounds herein allow for the easy integration of these compound(s) into the textile supply chain since they can be reactive dyes or cross-linking agents. In addition, the amount of selenium needed is much smaller than that needed for silver and does not require the selenium to leave the material. Silver must dissolve to act as an antimicrobial.

In one example, the invention is the chemical compound diseleniummonochlorotriazine. Triazines are commonly used in the textile chemistry to synthesis the reactive dye and apply to fabrics as they form covalent bonds with cellulose. Incorporating selenium creates a reactive dye with antimicrobial properties. This same base structure can be used to make diselenocyanuric chloride, diselenocyanuric bromide, diselenocyanuric fluoride, or diselenocyanuric iodine. Diseleniummonochlorotriazine exhibited both gram-negative and gram-positive antimicrobial activity to a level that matches industry expectations. In one example, the antimicrobial agent has the structure:

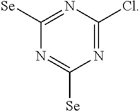

A technique for applying an organo-selenium coating/compound through the annealing process onto cotton fabric to create an inexpensive cotton material/fiber/yam exhibiting antimicrobial properties for protection against infectious diseases. The technology modifies triazines, a commonly used reactive dye within the textile chemistry for application to impart colors to fabrics, by incorporation of selenium to create a reactive dye with antimicrobial characteristics. Since the cotton manufacturing/processing industry currently relies on annealing of triazine to create colored fabrics, the presented technology can be incorporated into this sector with minimal changes in the production environment. The created compound, diseleniummonochlorotriazine, was evaluated in the laboratory by attaching the Se-based compound onto cotton fabrics with the following results: (1) Diseleniummonochlorotriazine killed 100% of Gram-positive bacteria (e.g., Staphylococcus aureus) that attempted to bind to the cotton, and (2) Diseleniummonochlorotriazine killed 90% of Gram-negative bacteria. (e.g., Pseudomonas aeruginosa) that attempted to bind to the cotton.

In another example the chemical compound is seleno-dihydroxypropane. These type of compounds are commonly used in the textile chemistry to cause cross linking for wrinkle resistance and are applied to fabrics as they form covalent bonds with cellulose. In one example, the antimicrobial agent has the structure:

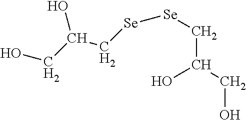 [SMILES: OCC(O)C[Se][Se]CC(O)CO]

Another example of this type of compound is seen below:

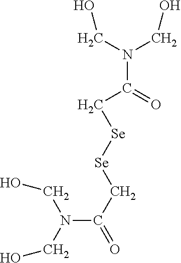 [SMILES: O=C(C[Se][Se]CC(=O)N(CO)CO)N(CO)CO]

While more general examples are:

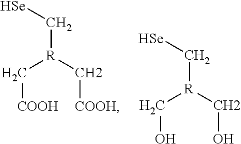

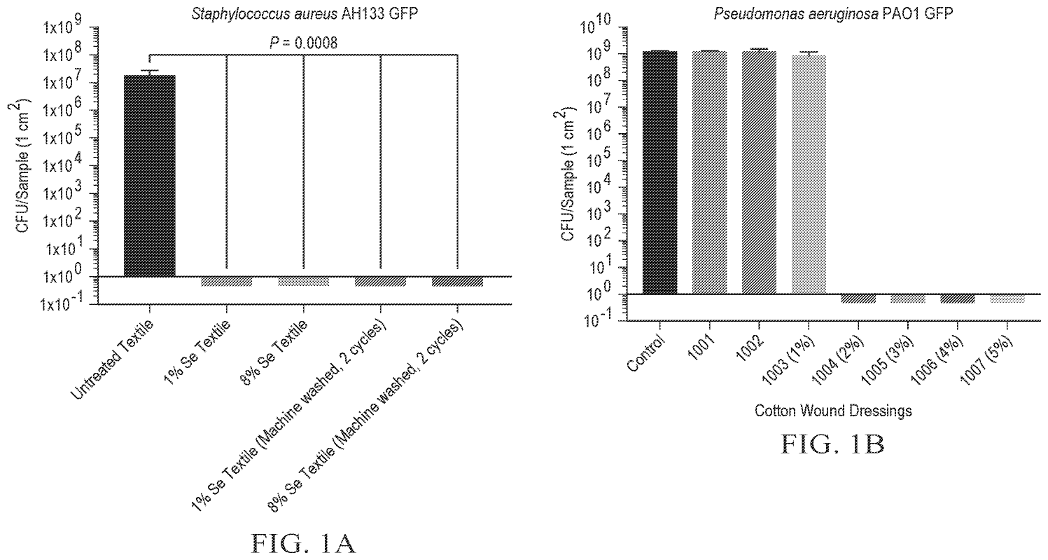

Example 1. Organo-selenium compounds were reacted with the cotton fabrics, which resulted in adding novel antimicrobial properties to the fabric. The application technique for the organo-selenium compound can be used by, e.g., the textile industry, on an industrial scale to produce an anti-microbial fabric. The testing focused on attaching Se-based compounds to cotton fabric. One test result of the fabric measuring the CFUs/sample of bacteria on the fabric, showing total bacterial killing, can be seen in FIGS. 1A and 1B. Antimicrobial kill graph for Staph. aureus is FIG. 1A and FIG. 1B for P. aeruginosa.

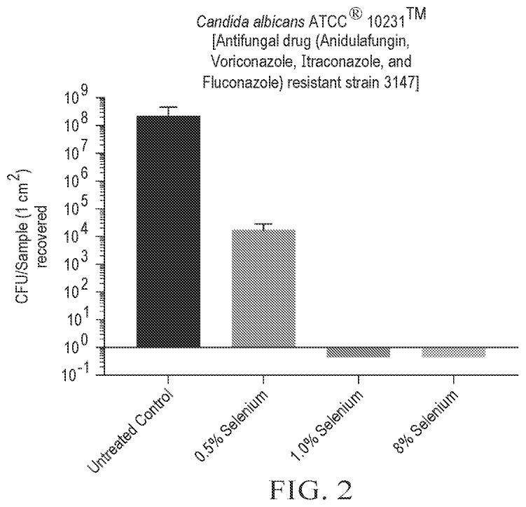

In addition, the antifungal activity of selenium-fiber material was tested against strain (3147), which is a strain of Candida albicans that is resistant to antifungal drugs (FIG. 2). Strong anti-fungal activity was found.

Briefly, the inventors developed organo-selenium compounds that can be attached to cotton yarns and is suitable for applications as reactive dye. After testing several compounds, it was found that diselenocyanuric chloride could achieve good binding to the cotton and would be resistant to multiple washings of the resulting fabric.

Next, the organoselenium-coated cotton was tested against different microbes. It was found that the resulting washed fabric coated with diselenocyanuric chloride was able to totally kill Staphylococcus aureus that was placed on the fabric.

It was found that diseleniummonochlorotriazine and 1-seleno-2,3-propanediol exhibited antimicrobial activity to a level that matches or exceed industrial requirements for anti-microbial activity.

Thus, it is shown herein that: (1) it was possible to attach an organo-selenium to the cotton using standard industrial techniques; and (2) with the organo-selenium cotton, the fabric was able to kill 100% of the Gram-positive bacteria tested. The material was able to kill 90-100% of the Gram-negative bacteria tested depending upon the fabric.

The present invention will wide use with, e.g., patients who have trouble with wound healing, such as diabetic wounds, bedsores, and burns, can get infections that are very difficult to heal and can lead to loss of limbs and death. It has been shown that bacteria can live in bandages and in clothing in contact with wounds and continually infect the wound. This can lead to a bacterial infection where the bacteria can form a film in the wound that is resistant to antimicrobials. The present invention produces a material or fabric, such as a cotton material, that actually functions to kill bacteria that attempt to live on it. The chemically-modified material taught herein is not only a barrier to bacteria, but also keep the skin surface clear of bacteria that could colonize a wound.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

1. A method of treating a textile with an antimicrobial agent, the method comprising:
contacting the textile with an antimicrobial agent that comprises a reactive dye or crosslinking agent comprising an organo-selenium compound in a treatment solution.

2. The method of claim 1, wherein the step of contacting the textile comprises dosing the textile with the treatment solution having a concentration of the antimicrobial agent sufficient to react with the textile, wherein the treatment solution comprises the organo-selenium compound solution.

3. The method of claim 1, wherein the treatment solution is an organo-selenium compound-based solution comprising the organo-selenium compound, water, salt, alkali and water.

4. The method of claim 1, wherein the organo-selenium compound is a diselenocyanuric chloride, diselenocyanuric bromide, diselenocyanuric fluoride, or diselenocyanuric iodine.

5. The method of claim 1, wherein the antimicrobial agent is selected from the following structures where R, is an organic moiety that facilitates the attachment of either the hydroxyl or carboxyl groups of the molecule, to the hydroxyls of cellulose, or molecules selected from:

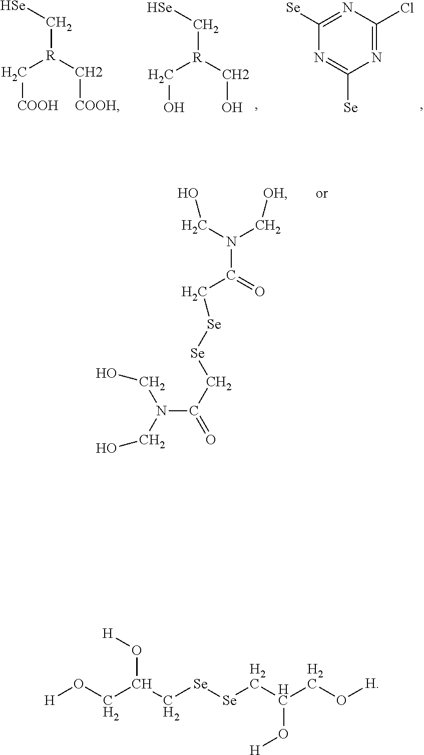

6. The method of claim 1, wherein the textile is at least one of:
antimicrobial against both gram positive and gram negative bacteria; or
antimicrobial without selenium in the organo-selenium compound leaching from the textile.

7. (canceled)

8. The method of claim 1, wherein the textile is at least one of:
cotton, wool, silk, hemp, viscose, pashm, camel, cashmere, mohair, rabbit, flax, linen, jute, ramie, sisal cork, ramie, jute, or coir; or
a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or a head covering.

9. The method of claim 1, further comprising blending the textile with one or more synthetic fibers to the textile selected from at least one of: rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof.

10. (canceled)

11. An antimicrobial textile made by a method comprising:
treating a textile with an antimicrobial agent, the method comprising:
contacting the textile with an antimicrobial agent that comprises a reactive dye comprising an organo-selenium compound in a treatment solution or a cross-linking organoselenium compound in a treatment solution.

12. The antimicrobial textile of claim 11, wherein the step of contacting the textile comprises dosing the textile with the treatment solution having a concentration of the antimicrobial agent sufficient to react with the textile, wherein the treatment solution is a foam-based solution.

13. The antimicrobial textile of claim 11, wherein the organo-selenium compound is a: diselenocyanuric chloride, diselenocyanuric bromide, diselenocyanuric fluoride, or diselenocyanuric iodine or other organoselenium crosslinking compounds, or wherein the antimicrobial agent has the more general structure where R, is an organic moiety that facilitates the attachment of either the hydroxyl or carboxyl groups of the molecule, to the hydroxyls of cellulose, or molecules selected from: 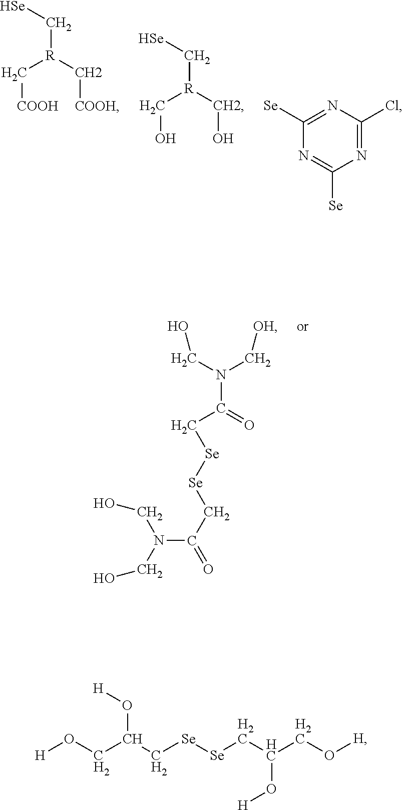
combinations thereof.

14. The antimicrobial textile of claim 11, wherein the treatment solution is a cross-linking organo-selenium compound, catalyst, wetting agent, and water.

15. The antimicrobial textile of claim 11, wherein the treatment solution is the organo-selenium compound, water, salt, alkali and water.

16. The antimicrobial textile of claim 11, wherein the textile is at least one of:
antimicrobial against both gram positive and gram negative bacteria; or
antimicrobial without selenium in the organo-selenium compound leaching from the textile.

17. (canceled)

18. The antimicrobial textile of claim 11, wherein the textile is at least one of:
cotton, wool, silk, hemp, viscose, pashm, camel, cashmere, mohair, rabbit, flax, linen, jute, ramie, sisal cork, ramie, jute, or coir; or
a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or a head covering.

19. The antimicrobial textile of claim 18, further comprising blending the textile with one or more synthetic fibers to the textile selected from at least one of: rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof.

20. (canceled)

21. A system for making an antimicrobial textile, the system comprising:
in a container contacting a textile with an antimicrobial agent that comprises a reactive dye comprising an organo-selenium compound in a treatment solution under conditions and for a time sufficient for the organo-selenium compound to chemically attach to the textile.

22. The system of claim 21, wherein the textile comprises fibers that are contacted to, or coated with, the antimicrobial agent comprising an organo-selenium reactive dye or a cross-linking agent.

23. The system of claim 21, wherein the organo-selenium compound is a diselenocyanuric chloride, diselenocyanuric bromide, diselenocyanuric fluoride, or diselenocyanuric iodine, or crosslinking structures, or wherein the antimicrobial agent has the structure where R, is an organic moiety that facilitates the attachment of either the hydroxyl or carboxyl groups of the molecule, to the hydroxyls of cellulose, or molecules selected from: 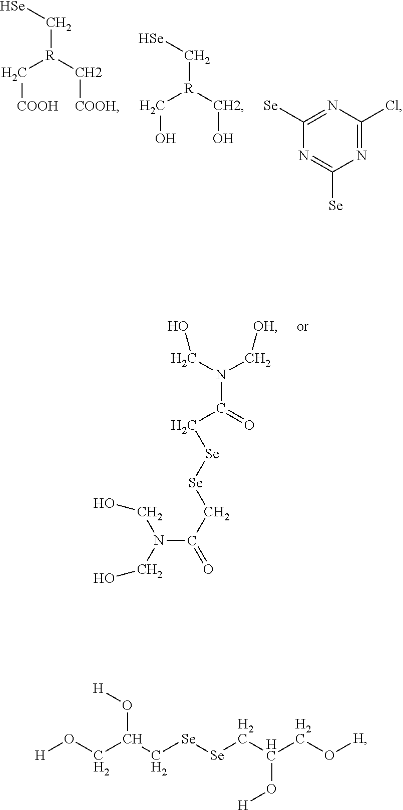
combinations thereof.

24. The system of claim 21, wherein the textile is at least one of:
antimicrobial against both gram positive and gram negative bacteria; or
antimicrobial without selenium in the organo-selenium compound leaching from the textile.

25. (canceled)

26. The system of claim 21, wherein the textile is at least one of:
cotton, wool, silk, hemp, viscose, pashm, camel, cashmere, mohair, rabbit, flax, linen, jute, ramie, sisal cork, ramie, jute, or coir; or
a yarn, a cloth, a swath, a bandage, a cast, a gown, a gauze, a lab coat, a mask, a shoe covering, a face covering, a curtain, a bedcovering, a carpeting, a blanket, a stretcher, a filter, a diaper, a dust cloth, a safety belt, a surgical gown, a woven fabric, a non-woven fabric, socks, undergarments, clothing, sanitary napkin, tampon, or a head covering.

27. The system of claim 21, further comprising blending the textile with one or more synthetic fibers to the textile selected from at least one of:
rayon, nylon, non-acrylic olefin, acrylic polyester, polytetrafluoroethylene, polypropylene, polypropylene ether, carbon fiber, vinyon, polyvinylidene chloride, spandex, vinalon, aramids, modal, polybenzimidazole, poly lactic acid, lyocell, polyacrylonitrile, liquid crystal polymer, acrylonitrile, or combinations thereof.

28. (canceled)
